(19) United States
(12) Patent Application Publication
(10) Pub. No.: US 2025/0023136 A1
(43) Pub. Date: Jan. 16, 2025

(54) TEMPERATURE CONTROL METHOD, ELECTRONIC DEVICE AND COMPUTER-READABLE STORAGE MEDIUM

(71) Applicant: Shenzhen CLOU Electronics CO., LTD, Shenzhen (CN)

(72) Inventors: Dongfang LI, Shenzhen (CN); Jinzhi LIU, Shenzhen (CN)

(73) Assignee: Shenzhen CLOU Electronics CO., LTD, Shenzhen (CN)

(21) Appl. No.: 18/641,913

(22) Filed: Apr. 22, 2024

(30) Foreign Application Priority Data
Jul. 10, 2023 (CN) 202310841286.5

(51) Int. Cl. H01M 10/633; H01M 10/48; H01M 10/613; H01M 10/6563

(52) U.S. Cl. CPC H01M 10/633; H01M 10/482; H01M 10/486; H01M 10/613; H01M 10/6563

(57) ABSTRACT

A temperature control method, an electronic device and a computer-readable storage medium are disclosed, the temperature state and the temperature change of the battery cluster are judged through the average temperature of the battery cluster and the temperature rising rate of the battery cluster, so that different temperature control strategies are selected; and the heat dissipation efficiency of the heat dissipation module of each battery module is controlled through the average temperature of each battery module in the battery cluster and the average temperature of the corresponding battery cluster, so that the battery cluster is controlled to subjected to temperature rise, temperature reduction, energy saving, temperature stability and the like, meanwhile, the temperature consistency of battery cells in the battery cluster can be improved, and the integral temperature consistency of the battery cluster is further improved.

### CROSS-REFERENCE TO RELATED APPLICATIONS

This application claims priority to Chinese patent application No. 202310841286.5 filed Jul. 10, 2023, the entire contents of which are incorporated herein by reference.

### TECHNICAL FIELD

Embodiments of the present disclosure relate to the technical field of energy storage systems, and in particular, to a temperature control method, an electronic device and a computer-readable storage medium.

### BACKGROUND

Energy storage system technology is one of support technologies for a smart grid. An energy storage system is integrated by a large number of battery cells, and the battery cell is arranged as a basic unit of the energy storage system. The temperature difference of the battery cells in the energy storage system has a great impact on the system service life, the state of health (SOH) of battery and the system balance.

In the existing technology, a heat dissipation module of the energy storage system, such as a speed adjustment strategy of a fan, is only controlled in partitions based on the average temperature of the battery module. When the energy storage system operates at a high rate for a long time, a large temperature difference usually occurs in the system. In particular, when there is a large difference in average temperature between different battery clusters, currents output by different battery clusters in a container are inconsistent, thereby reducing the output power of the system and reducing the energy efficiency. Therefore, how to improve the temperature consistency in the battery cluster is an urgent problem to be resolved at present.

### SUMMARY

Embodiments of the present disclosure provide a temperature control method, an electronic device and a computer-readable storage medium, which aim to improve the temperature consistency in the battery clusters.

In accordance with a first aspect of the present disclosure, an embodiment provides a temperature control method, which includes:
acquiring a temperature data set of a battery cluster, where the battery cluster includes a plurality of battery modules, each battery module includes at least one battery cell, and the temperature data set includes temperature data of each battery cell;
calculating an average temperature of the battery module, an average temperature of the battery cluster, a temperature rising rate of the battery cluster and a maximum temperature difference of the battery cluster according to the temperature data set;
in response to the average temperature of the battery cluster and the temperature rising rate of the battery cluster meeting a first condition, adjusting a heat dissipation efficiency of a heat dissipation module of each battery module according to the average temperature of each battery module and the average temperature of the battery cluster so as to reduce the temperature of the battery cluster, where a rotation speed of a fan is obtained according to a temperature range;
in response to the average temperature of the battery cluster and the temperature rising rate of the battery cluster meeting a second condition, adjusting the heat dissipation efficiency of the heat dissipation module of each battery module according to the average temperature of each battery module and the average temperature of the battery cluster so as to stabilize the temperature of the battery cluster;
in response to the average temperature of the battery cluster and the temperature rising rate of the battery cluster meeting a third condition, adjusting the heat dissipation efficiency of the heat dissipation module of each battery module according to the average temperature of each battery module and the average temperature of the battery cluster so as to rise the temperature of the battery cluster;
in response to the average temperature of the battery cluster meeting a fourth condition, adjusting a heat dissipation efficiency of a heat dissipation module of the battery module to a maximum efficiency state according to the average temperature of each battery module and the average temperature of the battery cluster; and
in response to the average temperature of the battery cluster and the maximum temperature difference of the battery cluster meeting a fifth condition, adjusting the heat dissipation module of the battery module to enter into an energy saving state according to the average temperature of each battery module and the average temperature of the battery cluster.

According to the temperature control method of the first aspect of the present disclosure, the temperature state and the temperature change of the battery cluster are judged through the average temperature of the battery cluster and the temperature rising rate of the battery cluster, so that different temperature control strategies are selected; and the heat dissipation efficiency of the heat dissipation module of each battery module is controlled based on the average temperature of each battery module in the battery cluster and the average temperature of the corresponding battery cluster, so that the battery cluster is controlled to subjected to temperature rise, temperature reduction, energy saving, temperature stability and the like. Meanwhile, the temperature consistency of battery cells in the battery cluster can be improved, the integral temperature consistency of the battery cluster is further improved, the excessive temperature difference inside the battery cluster and among different battery clusters is prevented, and thus the service life and the stability of an energy storage system are prolonged.

The first condition is that the average temperature of the battery cluster is less than or equal to a first threshold, and the temperature rising rate of the battery cluster is greater than a second threshold, where the second threshold is greater than 0;
the adjusting a heat dissipation efficiency of a heat dissipation module of each battery module according to the average temperature of each battery module and the average temperature of the battery cluster includes:
setting a plurality of temperature ranges according to a difference between the average temperature of the battery cluster and the average temperature of the battery module, where one of the temperature ranges corresponds to a duty ratio of the heat dissipation module, and the larger the difference corresponding to the temperature range is, the larger the duty ratio of the heat dissipation module is;
matching a temperature range corresponding to the battery module according to the average temperature of the battery module;
obtaining the duty ratio of the heat dissipation module according to the matched temperature range; and
controlling the heat dissipation efficiency of the heat dissipation module of the battery module according to the duty ratio of the heat dissipation module.

The second condition is that the average temperature of the battery cluster is less than or equal to a first threshold, and the temperature rising rate of the battery cluster is less than a second threshold and greater than a third threshold, where the second threshold is greater than 0, and the third threshold is less than 0;
the adjusting the heat dissipation efficiency of the heat dissipation module of each battery module according to the average temperature of each battery module and the average temperature of the battery cluster so as to stabilize the temperature of the battery cluster includes:
calculating a difference between the average temperature of the battery module and the average temperature of the battery cluster;
in response to the average temperature of the battery module being less than the average temperature of the battery cluster, based on a first preset duty ratio, reducing a duty ratio value according to the difference to obtain a duty ratio of the heat dissipation module of the battery module;
in response to the average temperature of the battery module being greater than the average temperature of the battery cluster, based on the first preset duty ratio, increasing the duty ratio value according to the difference to obtain the duty ratio of the heat dissipation module; and adjusting a corresponding heat dissipation efficiency of the heat dissipation module of the battery module according to the duty ratio of the heat dissipation module.

The maximum duty ratio of the heat dissipation module is 50%.

The third condition is that the average temperature of the battery cluster is less than or equal to a first threshold, and the temperature rising rate of the battery cluster is less than or equal to a third threshold, where the third threshold is less than 0;

the adjusting the heat dissipation efficiency of the heat dissipation module of each battery module according to the average temperature of each battery module and the average temperature of the battery cluster so as to rise the temperature of the battery cluster includes:

calculating a difference between the average temperature of the battery module and the average temperature of the battery cluster;
in response to the average temperature of the battery module being greater than the average temperature of the battery cluster, based on a second preset duty ratio, increasing a duty ratio value according to the difference to obtain a duty ratio of the heat dissipation module of the battery module;
in response to the average temperature of the battery module being less than the average temperature of the battery cluster, based on the second preset duty ratio, reducing the duty ratio value according to the difference to obtain the duty ratio of the heat dissipation module;
in response to the average temperature of the battery module being less than the average temperature of the battery cluster, and the difference between the average temperature of the battery module and the average temperature of the battery cluster being greater than a preset value, setting the duty ratio of the heat dissipation module to be 0%; and
adjusting a corresponding heat dissipation efficiency of the heat dissipation module of the battery module according to the duty ratio of the heat dissipation module.

The fourth condition is that the average temperature of the battery cluster is greater than a first threshold;

the adjusting a heat dissipation efficiency of a heat dissipation module of the battery module to a maximum efficiency state according to the average temperature of each battery module and the average temperature of the battery cluster includes:
in response to the average temperature of the battery module being greater than the average temperature of the battery cluster, setting a duty ratio of the heat dissipation module of the battery module to be a first preset high value;
in response to the average temperature of the battery module being less than or equal to the average temperature of the battery cluster, setting the duty ratio of the heat dissipation module to be a second preset high value; and
adjusting a corresponding fan of the battery module to a maximum rotation speed state according to the duty ratio of the heat dissipation module.

The fifth condition is that the average temperature of the battery cluster is less than a first threshold, and the maximum temperature difference of the battery cluster is less than a fourth threshold;
the adjusting a heat dissipation module of the battery module to enter into an energy saving state according to the average temperature of each battery module and the average temperature of the battery cluster includes:
in response to the average temperature of the battery module being greater than the average temperature of the battery cluster, setting a duty ratio of the heat dissipation module of the battery module to be a first preset low value;
in response to the average temperature of the battery module being less than or equal to the average temperature of the battery cluster, setting the duty ratio of the heat dissipation module to be a second preset low value; and
adjusting a corresponding heat dissipation efficiency of the heat dissipation module of the battery module according to the duty ratio of the heat dissipation module so as to enable the heat dissipation module of the battery module to enter into an energy saving state.

The temperature rising rate of the battery cluster is a difference between a maximum temperature of the battery cluster at a current moment and a maximum temperature of the battery cluster at a previous moment.

In accordance with a second aspect of the present disclosure, an embodiment provides an electronic device, including: one or more processors; a memory storing one or more programs, when executed by the one or more processors, cause the one or more processors to implement the temperature control method according to the first aspect.

In accordance with a third aspect of the present disclosure, an embodiment provides a non-transitory computer-readable storage medium storing a processor-executable program, when executed by a processor, is configured to implement the temperature control method according to the first aspect.

Other features and advantages of the present disclosure will be set forth in the specification below, and will be partly apparent from the specification or may be understood by implementing the present disclosure. The objectives and other advantages of the present disclosure will be implemented and attained by the structure particularly pointed out in the specification, claims and drawings.

### BRIEF DESCRIPTION OF DRAWINGS

FIG. 1 is a schematic diagram of a structure of an energy storage system according to an embodiment of the present disclosure;

FIG. 2 is a schematic diagram of a structure of a battery cluster according to an embodiment of the present disclosure;

FIG. 3 is a flowchart of a temperature control method according to an embodiment of the present disclosure; and

FIG. 4 is a schematic diagram of a structure of an electronic device according to an embodiment of the present disclosure.

### DETAILED DESCRIPTION

To make the objectives, technical solutions and advantages of the present disclosure more apparent, the present disclosure is further described in detail below with reference to the drawings and embodiments. It should be understood that the specific embodiments described herein are merely illustrative of the present disclosure and do not limit the present disclosure.

It should be noted that a functional module division is provided in a schematic diagram of a device and a logical sequence is shown in a flowchart. However, in some cases, the steps shown or described may be performed in a module division different from that of the device or in a sequence different from that of the flowchart. In the specification, claims, and the drawings, the terms “first”, “second”, and the like are intended to distinguish similar objects but do not necessarily indicate a specific order or sequence.

In the description of the present disclosure, unless otherwise explicitly defined, terms such as “arrange”, “mount”, “connect” and the like should be understood in a broad sense, and those skilled in the art can reasonably determine the specific meanings of the above terms in the embodiments of the present disclosure in conjunction with the specific contents of the technical solutions.

In the description of the present disclosure, the description with reference to the terms “one embodiment”, “some embodiments”, “schematic embodiment”, “example”, “specific example”, “some examples” or the like means the particular features, structures, materials or characteristics described in combination with the embodiment or example are included in at least one embodiment or example of the present disclosure. In this specification, the schematic expression of the above terms does not necessarily refer to the same embodiments or examples. Furthermore, the specific features, structures, materials, or characteristics described can be combined in any suitable manner in any one or more embodiments or examples.

In the existing technology, energy storage system technology is one of support technologies for a smart grid. An energy storage system is integrated by a large number of battery cells, and the battery cell is arranged as a basic unit of the energy storage system. The temperature difference of the battery cells in the energy storage system has a great impact on the system service life, the state of health (SOH) and the system balance.

In the existing technology, to reduce the temperature difference between the battery cells in the energy storage system and prolong the system usage time, an energy storage battery module is generally provided with a fan and adjusts a speed of the fan to regulate the internal temperature difference. At present, a speed adjustment strategy of the fan of the energy storage system is only controlled in partitions based on the average temperature of the battery module. When the energy storage system operates at a high rate for a long time, a large temperature difference usually occurs in the system. In particular, when there is a large difference in average temperature between different battery clusters, currents output by different battery clusters in a container are inconsistent; thereby reducing the output power of the system, and reducing the energy efficiency. Therefore, how to improve the temperature consistency in the battery cluster is an urgent problem to be resolved at present.

An embodiment of the present disclosure provide a temperature control method, an electronic device and a computer-readable storage medium, where the temperature state and the temperature change of the battery cluster are judged through the average temperature of the battery cluster and the temperature rising rate of the battery cluster, so that different temperature control strategies are selected; and the heat dissipation efficiency of the heat dissipation module of each battery module is controlled based on the average temperature of each battery module in the battery cluster and the average temperature of the corresponding battery cluster, so that the battery cluster is controlled to subjected to temperature rise, temperature reduction, energy saving, temperature stability and the like. Meanwhile, the temperature consistency of battery cells in the battery cluster can be improved, the integral temperature consistency of the battery cluster is further improved, the excessive temperature difference inside of the battery cluster and among different battery clusters is prevented, and the service life and the stability of an energy storage system are prolonged. According to the embodiments of the present disclosure, the average temperature of the battery cluster is taken as a reference, a duty ratio of a module fan corresponding to the battery module is increased or reduced according to a difference between the average temperature of each battery module in the battery cluster and the average temperature of the corresponding battery cluster, and thus each battery module is controlled. The method of the present disclosure does not merely increase or reduce the rotation speed uniformly but controls the overall temperature of the battery cluster, so that the temperature difference between the battery modules in the battery cluster is maintained within a target range, the temperature consistency of the battery cells in the energy storage system is improved, the service life of the energy storage system is prolonged, and the operating stability is improved.

The following further describes embodiments of the present disclosure with reference to the drawings.

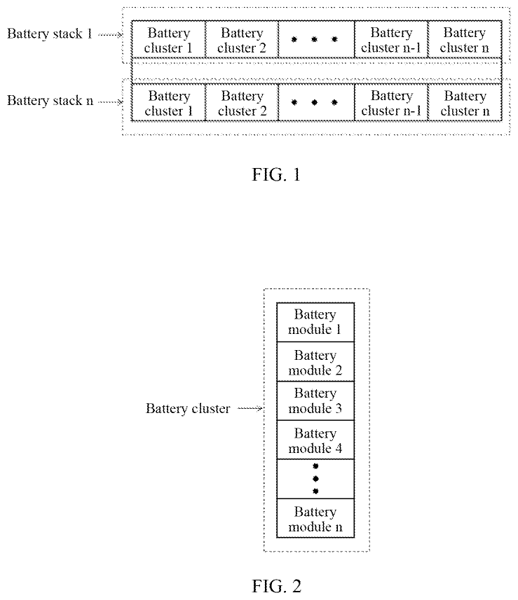

FIG. 1 is a schematic diagram of a structure of an energy storage system according to an embodiment of the present disclosure. As shown in FIG. 1, the energy storage system includes n battery stacks, and each battery stack includes n battery clusters. In an example, the energy storage system is an energy storage container.

Each battery cluster includes n battery modules, and each battery module includes at least one battery cell. As shown in FIG. 2, each battery module is equipped with a fan module, the fan module is configured to dissipate heat of the battery module, and each battery cell is equipped with a temperature sensor to detect and report the real-time temperature of the battery cell.

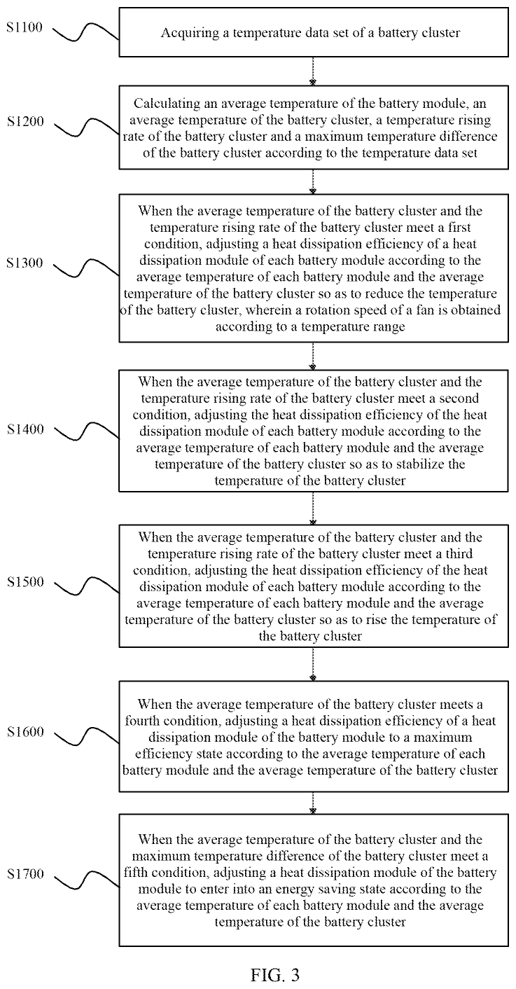

FIG. 3 is a flowchart of a temperature control method according to an embodiment of the present disclosure. As shown in FIG. 3, the temperature control method may be applied to, but is not limited to, the energy storage system as provided in FIG. 1. The temperature control method at least includes but is not limited to steps S1100, S1200, S1300, S1400, S1500, S1600 and S1700.

S1100: acquiring a temperature data set of a battery cluster, the battery cluster includes a plurality of battery modules, each battery module includes at least one battery cell, and the temperature data set includes temperature data of each battery cell.

S1200: calculating an average temperature of the battery module, an average temperature of the battery cluster, a temperature rising rate of the battery cluster and a maximum temperature difference of the battery cluster according to the temperature data set.

In an embodiment, the average temperature of the battery modules is set as T_{B}, and the average temperature of each battery module is obtained by averaging the temperatures in the battery module.

In an embodiment, the average temperature of the battery cluster is set as T_{A}, and the average temperature of each battery cluster is obtained by averaging the average temperatures of the battery modules in the battery cluster.

In an embodiment, the temperature rising rate of the battery cluster is a difference between a maximum temperature of the battery cluster at a current moment and a maximum temperature of the battery cluster at a previous moment.

The battery cluster provided in FIG. 2 is used as an example, the maximum temperature T_{A max} of the battery cluster is set and obtained by the following formula: T_{A max}=max{T_{B1 max}, T_{B2 max}, T_{B3 max}, . . . }, where T_{B1 max} is the highest module temperature of the battery module 1, T_{B2 max} is the highest module temperature of the battery module 2, and so on; and the highest temperature of the battery module T_{B max} is a maximum value of the temperatures of the battery cells in the battery module.

The temperature rising rate of the battery cluster is the temperature rising rate per minute of the highest temperature of the battery cluster, and the temperature rise efficiency of the battery cluster is ΔT=(T₀+1 min) T_{A max}−(T₀)T_{A max}; where ΔT>0 indicates that the temperature of the battery cluster increases, and ΔT<0 indicates that the temperature of the battery cluster deceases.

In an embodiment, the maximum temperature difference of the battery cluster is T_{ΔA}=T_{A max}−T_{A min}, where T_{A min}=min{T_{B1 min}, T_{B2 min}, T_{B3 min}, . . . }, where T_{B1 min} is the lowest module temperature of the battery module 1, T_{B2 min} is the lowest module temperature of the battery module 2, and so on; and the lowest temperature of the battery module T_{B min} is a minimum value of the temperatures of the battery cells in the battery module.

S1300: when the average temperature of the battery cluster and the temperature rising rate of the battery cluster meet a first condition, adjusting a heat dissipation efficiency of a heat dissipation module of each battery module according to the average temperature of each battery module and the average temperature of the battery cluster so as to reduce the temperature of the battery cluster, where a rotation speed of a fan is obtained according to a temperature range. The heat dissipation module includes a module fan, and one battery module is correspondingly provided with one module fan. By adjusting the duty ratio of the heat dissipation module (namely a proportion of the power-on time of the heat dissipation module in the total time in a pulse cycle), when the heat dissipation module is the module fan, the heat dissipation efficiency is the duty ratio of the module fan

In an embodiment, the first condition is that the average temperature of the battery cluster is less than or equal to a first threshold, and the temperature rising rate of the battery cluster is greater than a second threshold, where the second threshold is greater than 0;
the adjusting a heat dissipation efficiency of a heat dissipation module of each battery module according to the average temperature of each battery module and the average temperature of the battery cluster includes:
setting a plurality of temperature ranges according to a difference between the average temperature of the battery cluster and the average temperature of the battery module, one of the temperature ranges corresponds to a duty ratio of the heat dissipation module, and the larger the difference corresponding to the temperature range is, the larger the duty ratio of the heat dissipation module is;
matching a temperature range corresponding to the battery module according to the average temperature of the battery module;
obtaining the duty ratio of the heat dissipation module according to the matched temperature range; and
controlling the heat dissipation efficiency of the heat dissipation module of the battery module according to the duty ratio of the heat dissipation module.

For example, in the energy storage system provided in FIG. 1 and FIG. 2, when the first threshold is set as 27° C. and the second threshold is set as 0.2° C./min, the first condition is that the average temperature of the battery cluster T_{A} is less than or equal to 27° C., and the temperature rise efficiency of the battery cluster ΔT is greater than or equal to 0.2° C./min. Correspondingly, when the first condition is met, the duty ratio of the module fan of the battery module is controlled through temperature rising and regression strategy. The specific control strategy is as follows:
when T_{B}<T_{A}, the duty ratio of the module fan is 5%;
when T_{B}≥T_{A}, the duty ratio of the module fan is 20%;
when T_{B}≥T_{A}+1, the duty ratio of the module fan is 40%;
when T_{B}≥T_{A}+2, the duty ratio of the module fan is 60%;
when T_{B}≥T_{A}+3, the duty ratio of the module fan is 80%; and
when T_{B}≥T_{A}+4, the duty ratio of the module fan is 100%.

When the average temperature of the battery cluster and the temperature rising rate of the battery cluster meet the first condition, it can be confirmed that the battery cluster is in a temperature rising state. A range of the difference between the average temperature of each battery module and the average temperature of the battery cluster is judged based on the temperature rising and regression strategy, and then the corresponding rotation speed of the fan of the battery module is adjusted according to the duty ratio of the module fan obtained by matching. On this basis, while controlling the temperature of the battery cluster, the fan rotation speed of each battery module is controlled according to the temperature difference relationship between each of battery modules and the battery cluster, so as to prevent the temperature difference between battery modules from being too large.

S1400: when the average temperature of the battery cluster and the temperature rising rate of the battery cluster meet a second condition, adjusting the heat dissipation efficiency of the heat dissipation module of each battery module according to the average temperature of each battery module and the average temperature of the battery cluster so as to stabilize the temperature of the battery cluster.

In an embodiment, the second condition is that the average temperature of the battery cluster is less than or equal to a first threshold, and the temperature rising rate of the battery cluster is less than a second threshold and greater than a third threshold, where the second threshold is greater than 0, and the third threshold is less than 0;
the adjusting the heat dissipation efficiency of the heat dissipation module of each battery module according to the average temperature of each battery module and the average temperature of the battery cluster so as to stabilize the temperature of the battery cluster includes:
calculating a difference between the average temperature of the battery module and the average temperature of the battery cluster;
when the average temperature of the battery module is less than the average temperature of the battery cluster, based on a first preset duty ratio, reducing a duty ratio value according to the difference to obtain a duty ratio of the heat dissipation module of the battery module;
when the average temperature of the battery module is greater than the average temperature of the battery cluster, based on the first preset duty ratio, increasing the duty ratio value according to the difference to obtain the duty ratio of the heat dissipation module; and
adjusting a corresponding heat dissipation efficiency of the heat dissipation module of the battery module according to the duty ratio of the heat dissipation module.

In an embodiment, the maximum duty ratio of the heat dissipation module is 50%.

For example, in the energy storage system provided in FIG. 1 and FIG. 2, when the first threshold is set as 27° C., the second threshold is set as 0.2° C./min and the third threshold is −0.2° C./min, the second condition is that the average temperature of the battery cluster T_{A} is less than or equal to 27° C., −0.2° C./min<ΔT<0.2° C./min. Correspondingly, when the second condition is met, the duty ratio of the module fan of the battery module is controlled through a smooth temperature fluctuation strategy. The smooth temperature fluctuation strategy is as follows:
the first preset duty ratio is set as 25%, where i is a difference between the average temperature of the battery cluster and the average temperature of the battery module;
when T_{B}≤T_{A}−i, the duty ratio of the module fan is (25−10i) %, and when 25−10i≤0, the fan stops rotating; and
when T_{B}≥T_{A}+i, the duty ratio of the module fan is (25+10i) %, and when 25+10i>50, the fan maintains at a fixed duty ratio of 50%.

When the average temperature of the battery cluster and the temperature rising rate of the battery cluster meet the second condition, it can be confirmed that the current temperature of the battery cluster is in a relatively stable state. Based on the smooth temperature fluctuation strategy, the duty ratio of the module fan of battery module whose average temperature is greater than the average temperature of the battery cluster is increased, and the duty ratio of the module fan of the battery module whose average temperature is less than the average temperature of the battery cluster is reduced, and thus the temperature difference between the battery modules is reduced while maintaining the temperature stability of the battery cluster. Based on this strategy, when the average temperature of the battery module is 2.5° C. less than the average temperature of the battery cluster, the fan stops rotating; when the average temperature of the battery module is greater than the average temperature of the battery cluster by 2.5° C., the rotation speed of the fan is controlled within 50%. Therefore, it can be ensured that the change of the middle rotation speed has better continuity, and the whole battery module can adapt to the self-adaptive smooth speed adjustment within the temperature range of 5° C.

S1500: when the average temperature of the battery cluster and the temperature rising rate of the battery cluster meet a third condition, adjusting the heat dissipation efficiency of the heat dissipation module of each battery module according to the average temperature of each battery module and the average temperature of the battery cluster so as to rise the temperature of the battery cluster.

In an embodiment, the third condition is that the average temperature of the battery cluster is less than or equal to a first threshold, and the temperature rising rate of the battery cluster is less than or equal to a third threshold, where the third threshold is less than 0;
the adjusting the heat dissipation efficiency of the heat dissipation module of each battery module according to the average temperature of each battery module and the average temperature of the battery cluster so as to rise the temperature of the battery cluster includes:
calculating a difference between the average temperature of the battery module and the average temperature of the battery cluster;
when the average temperature of the battery module is greater than the average temperature of the battery cluster, based on a second preset duty ratio, increasing a duty ratio value according to the difference to obtain a duty ratio of the heat dissipation module of the battery module;
when the average temperature of the battery module is less than the average temperature of the battery cluster, based on the second preset duty ratio, reducing the duty ratio value according to the difference to obtain the duty ratio of the heat dissipation module;
when the average temperature of the battery module is less than the average temperature of the battery cluster, and the difference between the average temperature of the battery module and the average temperature of the battery cluster is greater than a preset value, setting the duty ratio of the heat dissipation module to be 0%; and
adjusting a corresponding heat dissipation efficiency of the heat dissipation module of the battery module according to the duty ratio of the heat dissipation module.

For example, in the energy storage system provided in FIG. 1 and FIG. 2, when the first threshold is set as 27° C. and the third threshold is set as −0.2° C./min, the third condition is that the average temperature of the battery cluster T_{A} is less than or equal to 27° C., ΔT≤−0.2° C./min. Correspondingly, when the third condition is met, the duty ratio of the module fan of the battery module is controlled through temperature reduction and regression strategy. The specific control strategy is as follows:
the second preset duty ratio is set as 20%, where i is a difference between the average temperature of the battery cluster and the average temperature of the battery module;
when T_{B}≥T_{A}+i, the duty ratio of the module fan is (20+20i)%, ≤i≤0;
when T_{B}≤T_{A}−i, the duty ratio of the module fan is (20−10i)%, 0≤i≤2; and
when T_{B}≤T_{A}−2, the module fan stops rotating.

When the average temperature of the battery cluster and the temperature rising rate of the battery cluster meet the third condition, it can be confirmed that the current temperature of the battery cluster is in a temperature reduction state. Based on the temperature reduction and regression strategy, the duty ratio of the module fan of the battery module whose average temperature is less than the average temperature of the battery cluster is reduced, and the fan of the battery module with the difference exceeding a threshold (such as 2° C.) directly stops rotating so as to reduce the heat dissipation effect of the fan, so that the overall temperature of the battery cluster can gradually increase to a target value, and the normal operation of the system is ensured. Meanwhile, the duty ratio of the module fan of battery module whose average temperature is greater than the average temperature of the battery cluster is increased, so that some battery modules with too high temperature can quickly cool down to prevent the temperature difference between battery modules from being too large.

S1600: when the average temperature of the battery cluster meets a fourth condition, adjusting a heat dissipation efficiency of a heat dissipation module of the battery module to a maximum efficiency state according to the average temperature of each battery module and the average temperature of the battery cluster.

In an embodiment, the fourth condition is that the average temperature of the battery cluster is greater than a first threshold;
the adjusting a heat dissipation efficiency of a heat dissipation module of the battery module to a maximum efficiency state according to the average temperature of each battery module and the average temperature of the battery cluster includes:
when the average temperature of the battery module is greater than the average temperature of the battery cluster, setting a duty ratio of the heat dissipation module of the battery module to be a first preset high value;
when the average temperature of the battery module is less than or equal to the average temperature of the battery cluster, setting the duty ratio of the heat dissipation module to be a second preset high value; and
adjusting a corresponding fan of the battery module to a maximum rotation speed state according to the duty ratio of the heat dissipation module.

For example, in the energy storage system provided in FIG. 1 and FIG. 2, when the first threshold is set as 27° C., the fourth condition is that the average temperature of the battery cluster T_{A} is greater than 27° C. Correspondingly, when the fourth condition is met, the duty ratio of the module fan of the battery module is controlled through a high temperature strategy. The specific control strategy is as follows:
the first preset high value is set as 100%, and the second preset high value is set as 60%;
when T_{B}≤T_{A}, the duty ratio of the module fan is 60%; and
when T_{B}>T_{A}, the duty ratio of the module fan is 100%.

When the average temperature of the battery cluster meets the fourth condition, it can be confirmed that the current battery cluster is in a high-temperature state, and real-time rapid temperature reduction needs to be performed. Based on the high temperature strategy, the duty ratio of the module fan of the battery module whose average temperature is less than the average temperature of the battery cluster is directly set as 60%; the duty ratio of the module fan of battery module whose average temperature is greater than the average temperature of the battery cluster is directly set as 100%, and the fan of the battery module in different temperature states is adjusted to the maximum rotation speed state, so that the heat dissipation efficiency of the heat dissipation module is adjusted to the maximum efficiency state. On this basis, when the entire battery cluster is rapidly cooled, the temperature difference between the battery modules can be ensured to be within a target range.

S1700: when the average temperature of the battery cluster and the maximum temperature difference of the battery cluster meet a fifth condition, adjusting a heat dissipation module of the battery module to enter into an energy saving state according to the average temperature of each battery module and the average temperature of the battery cluster.

In an embodiment, the fifth condition is that the average temperature of the battery cluster is less than a first threshold, and the maximum temperature difference of the battery cluster is less than a fourth threshold;
the adjusting a heat dissipation module of the battery module to enter into an energy saving state according to the average temperature of each battery module and the average temperature of the battery cluster includes:
when the average temperature of the battery module is greater than the average temperature of the battery cluster, setting a duty ratio of the heat dissipation module of the battery module to be a first preset low value;
when the average temperature of the battery module is less than or equal to the average temperature of the battery cluster, setting the duty ratio of the heat dissipation module to be a second preset low value; and
adjusting a corresponding heat dissipation efficiency of the heat dissipation module of the battery module according to the duty ratio of the heat dissipation module so as to enable the heat dissipation module of the battery module to enter into an energy saving state.

For example, in the energy storage system provided in FIG. 1 and FIG. 2, when the first threshold is set as 27° C. and the fourth threshold is set as 5° C., the fifth condition is that the average temperature of the battery cluster T_{A} is less than 27° C., and the maximum temperature difference of the battery cluster T_{ΔA} is less than 27° C. Correspondingly, when the fifth condition is met, the duty ratio of the module fan of the battery module is controlled through an energy saving strategy. The specific control strategy is as follows:
the first preset low value is set as 20%, and the second preset low value is set as 5%;
when T_{B}≤T_{A}, the duty ratio of the module fan is 5%; and
when T_{B}>T_{A}, the duty ratio of the module fan is 20%.

When the average temperature of the battery cluster meets the fifth condition, it can be confirmed that the current temperature of the battery cluster is in a target operating state, and the temperature rising and the temperature reduction are not needed. Based on the energy saving strategy, the duty ratio of the module fan of the battery module whose average temperature is less than or equal to the average temperature of the battery cluster is directly set as 5%, on this basis, the rotation speed of the fan of the battery module is at the lowest value that can maintain the stability of the overall temperature of the battery cluster to save energy. Meanwhile, the duty ratio of the module fan of battery module whose average temperature is greater than the average temperature of the battery cluster is directly set as 20%, and the battery modules with relatively high temperature are cooled at a low fan rotation speed, so that the temperature difference between the battery modules is reduced, and the overall operation of the battery cluster is stable.

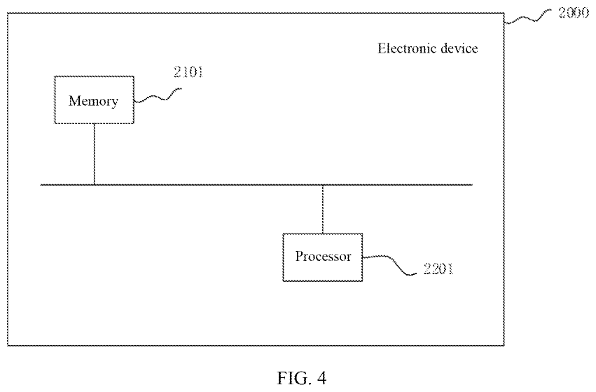

FIG. 4 is a schematic diagram of a structure of an electronic device according to an embodiment of the present disclosure. As shown in FIG. 4, the electronic device 2000 includes a memory 2100 and a processor 2200. There are one or more memories 2100 and the processors 2200. FIG. 4 illustrates one memory 2101 and one processor 2201, and the memory 2101 and the processor 2201 in a network device can be connected by a bus or other means, such as a bus connection in FIG. 4.

As a non-transitory computer-readable storage medium, the memory 2101 may be configured to store a software program, a computer-executable program and a module, such as program instructions/modules corresponding to the method provided in any one of the embodiments of the present application. The processor 2201 implements the temperature control method according to any one of the embodiments by running software programs, instructions and modules stored in the memory 2101.

The memory 2101 may mainly include a program storage area and a data storage area. The program storage area can store an operating system and an application program that is required for at least one function. In addition, the memory 2101 may include a high-speed random access memory, and may further include a non-volatile memory such as at least one magnetic disk storage device, a flash memory or another non-volatile solid-state storage device. In some examples, the memory 2101 further includes memories that are remotely disposed relative to the processor 2201, and the remote memories may be connected to the electronic device over a network. Examples of the foregoing networks include but are not limited to the internet, an enterprise intranet, a local area network, a mobile communications network, and a combination thereof.

An embodiment of the present disclosure further provides a non-transitory computer-readable storage medium storing computer-executable instructions, where the computer-executable instructions are configured to perform the temperature control method according to any one of the embodiments of the present disclosure.

An embodiment of the present disclosure further provides a computer program product, including a computer program or a computer instruction stored in a computer-readable storage medium, when a processor of a computer device reads the computer program or the computer instruction from the computer-readable storage medium, the processor executes the computer program or the computer instruction, so that the computer device performs the temperature control method according to any one of the embodiments of the present disclosure.

A system architecture and an application scenario described in embodiments of the present disclosure are intended to describe the technical solutions in the embodiments of the present disclosure more clearly, and do not constitute a limitation on the technical solutions provided in embodiments of the present disclosure. Those skilled in the art may know that with evolution of a network architecture and emergence of a new application scenario, the technical solutions provided in embodiments of the present disclosure are also applicable to similar technical problems.

It will be understood by those of ordinary skill in the art that all or some steps, systems and functional modules/units in the device disclosed above can be implemented as software, firmware, hardware and suitable combinations thereof.

In a hardware implementation, the division between functional modules/units mentioned in the above description does not necessarily correspond to the division of physical components; for example, one physical component may have multiple functions, or one function or step may be performed cooperatively by several physical components. Some or all of the physical components may be implemented as software executed by a processor, such as a central processing unit, a digital signal processor or a microprocessor, or as hardware, or as an integrated circuit, such as an application specific integrated circuit. Such software may be distributed on the computer-readable medium, and the computer-readable medium may include a computer storage medium (or a non-transitory medium) and a communication medium (or a transitory medium). It is well known to those of ordinary skill in the art that the term “computer storage medium” includes volatile and nonvolatile, removable and non-removable medium implemented in any method or technology for storage of information such as computer-readable instructions, data structures, program modules or other data. The computer storage medium includes, but is not limited to, RAM, ROM, EEPROM, a flash memory or other memory technologies, CD-ROM, a digital video disc (DVD) or other optical disk storage, a magnetic cassette, a magnetic tape, magnetic disk storage or other magnetic storage apparatuses, or any other medium that can be used to store the desired information and can be accessed by a computer. In addition, it is well known to those of ordinary skill in the art that communication medium typically embodies computer-readable instructions, data structures, program modules or other data in a modulated data signal such as a carrier wave or other transport mechanism and may include any information delivery medium.

Terms such as “component”, “module” and “system” used in this specification indicate computer-related entities, hardware, firmware, combinations of hardware and software, software, or software being executed. For example, a component may be, but is not limited to, a process that runs on a processor, a processor, an object, an executable file, a thread of execution, a program or a computer. As illustrated by using figures, both a computing device and an application that runs on the computing device may be components. One or more components may reside within a process or an execution thread, and a component may be located on one computer or distributed between two or more computers. In addition, these components may be executed by various computer-readable media that store various data structures. For example, the components may communicate by using a local or remote process and based on a signal having one or more data packets (for example, data from two components interacting with another component in a local system, a distributed system or across a network such as an internet interacting with another system by using the signal).

Some embodiments of the present disclosure have been described above with reference to the drawings, but the scope of rights of the present disclosure is not thereby limited. Any modifications, equivalent substitutions and improvements made by those skilled in the art without departing from the scope and essence of the present disclosure shall be within the scope of rights of the present disclosure.

What is claimed is:

1. A temperature control method, comprising:
acquiring a temperature data set of a battery cluster, wherein the battery cluster comprises a plurality of battery modules, each battery module comprises at least one battery cell, and the temperature data set comprises temperature data of each battery cell;
calculating an average temperature of the battery module, an average temperature of the battery cluster, a temperature rising rate of the battery cluster and a maximum temperature difference of the battery cluster according to the temperature data set;
in response to the average temperature of the battery cluster and the temperature rising rate of the battery cluster meeting a first condition, adjusting a heat dissipation efficiency of a heat dissipation module of each battery module according to the average temperature of each battery module and the average temperature of the battery cluster so as to reduce the temperature of the battery cluster, wherein a rotation speed of a fan is obtained according to a temperature range;
in response to the average temperature of the battery cluster and the temperature rising rate of the battery cluster meeting a second condition, adjusting the heat dissipation efficiency of the heat dissipation module of each battery module according to the average temperature of each battery module and the average temperature of the battery cluster so as to stabilize the temperature of the battery cluster;
in response to the average temperature of the battery cluster and the temperature rising rate of the battery cluster meeting a third condition, adjusting the heat dissipation efficiency of the heat dissipation module of each battery module according to the average temperature of each battery module and the average temperature of the battery cluster so as to rise the temperature of the battery cluster;
in response to the average temperature of the battery cluster meeting a fourth condition, adjusting a heat dissipation efficiency of a heat dissipation module of the battery module to a maximum efficiency state according to the average temperature of each battery module and the average temperature of the battery cluster; and
in response to the average temperature of the battery cluster and the maximum temperature difference of the battery cluster meeting a fifth condition, adjusting the heat dissipation module of the battery module to enter into an energy saving state according to the average temperature of each battery module and the average temperature of the battery cluster.

2. The temperature control method according to claim 1, wherein the first condition is that the average temperature of the battery cluster is less than or equal to a first threshold, and the temperature rising rate of the battery cluster is greater than a second threshold, wherein the second threshold is greater than 0;
the adjusting a heat dissipation efficiency of a heat dissipation module of each battery module according to the average temperature of each battery module and the average temperature of the battery cluster comprises:
setting a plurality of temperature ranges according to a difference between the average temperature of the battery cluster and the average temperature of the battery module, wherein one of the temperature ranges corresponds to a duty ratio of the heat dissipation module, and the larger the difference corresponding to the temperature range is, the larger the duty ratio of the heat dissipation module is;
matching a temperature range corresponding to the battery module according to the average temperature of the battery module;
obtaining the duty ratio of the heat dissipation module according to the matched temperature range; and
controlling the heat dissipation efficiency of the heat dissipation module of the battery module according to the duty ratio of the heat dissipation module.

3. The temperature control method according to claim 1, wherein the second condition is that the average temperature of the battery cluster is less than or equal to a first threshold, and the temperature rising rate of the battery cluster is less than a second threshold and greater than a third threshold, wherein the second threshold is greater than 0, and the third threshold is less than 0;
the adjusting the heat dissipation efficiency of the heat dissipation module of each battery module according to the average temperature of each battery module and the average temperature of the battery cluster so as to stabilize the temperature of the battery cluster comprises:
calculating a difference between the average temperature of the battery module and the average temperature of the battery cluster;
in response to the average temperature of the battery module being less than the average temperature of the battery cluster, based on a first preset duty ratio, reducing a duty ratio value according to the difference to obtain a duty ratio of the heat dissipation module of the battery module;
in response to the average temperature of the battery module being greater than the average temperature of the battery cluster, based on the first preset duty ratio, increasing the duty ratio value according to the difference to obtain the duty ratio of the heat dissipation module; and
adjusting a corresponding heat dissipation efficiency of the heat dissipation module of the battery module according to the duty ratio of the heat dissipation module.

4. The temperature control method according to claim 3, wherein a maximum duty ratio of the heat dissipation module is 50%.

5. The temperature control method according to claim 1, wherein the third condition is that the average temperature of the battery cluster is less than or equal to a first threshold, and the temperature rising rate of the battery cluster is less than or equal to a third threshold, wherein the third threshold is less than 0;
the adjusting the heat dissipation efficiency of the heat dissipation module of each battery module according to the average temperature of each battery module and the average temperature of the battery cluster so as to rise the temperature of the battery cluster comprises:
calculating a difference between the average temperature of the battery module and the average temperature of the battery cluster;
in response to the average temperature of the battery module being greater than the average temperature of the battery cluster, based on a second preset duty ratio, increasing a duty ratio value according to the difference to obtain a duty ratio of the heat dissipation module of the battery module;
in response to the average temperature of the battery module being less than the average temperature of the battery cluster, based on the second preset duty ratio, reducing the duty ratio value according to the difference to obtain the duty ratio of the heat dissipation module;
in response to the average temperature of the battery module being less than the average temperature of the battery cluster, and the difference between the average temperature of the battery module and the average temperature of the battery cluster being greater than a preset value, setting the duty ratio of the heat dissipation module to be 0%; and
adjusting a corresponding heat dissipation efficiency of the heat dissipation module of the battery module according to the duty ratio of the heat dissipation module.

6. The temperature control method according to claim 1, wherein the fourth condition is that the average temperature of the battery cluster is greater than a first threshold;
the adjusting a heat dissipation efficiency of a heat dissipation module of the battery module to a maximum efficiency state according to the average temperature of each battery module and the average temperature of the battery cluster comprises:
in response to the average temperature of the battery module being greater than the average temperature of the battery cluster, setting a duty ratio of the heat dissipation module of the battery module to be a first preset high value;
in response to the average temperature of the battery module being less than or equal to the average temperature of the battery cluster, setting the duty ratio of the heat dissipation module to be a second preset high value; and
adjusting a corresponding fan of the battery module to a maximum rotation speed state according to the duty ratio of the heat dissipation module.

7. The temperature control method according to claim 1, wherein the fifth condition is that the average temperature of the battery cluster is less than a first threshold, and the maximum temperature difference of the battery cluster is less than a fourth threshold;
the adjusting a heat dissipation module of the battery module to enter into an energy saving state according to the average temperature of each battery module and the average temperature of the battery cluster comprises:
in response to the average temperature of the battery module being greater than the average temperature of the battery cluster, setting a duty ratio of the heat dissipation module of the battery module to be a first preset low value;
in response to the average temperature of the battery module being less than or equal to the average temperature of the battery cluster, setting the duty ratio of the heat dissipation module to be a second preset low value; and
adjusting a corresponding heat dissipation efficiency of the heat dissipation module of the battery module according to the duty ratio of the heat dissipation module so as to enable the heat dissipation module of the battery module to enter into an energy saving state.

8. The temperature control method according to claim 1, wherein the temperature rising rate of the battery cluster is a difference between a maximum temperature of the battery cluster at a current moment and a maximum temperature of the battery cluster at a previous moment.

9. An electronic device, comprising:
one or more processors; and
a memory storing one or more programs, when executed by the one or more processors, cause the one or more processors to implement:
the temperature control method according to claim 1.

10. A non-transitory computer-readable storage medium storing a processor-executable program, when executed by a processor, is configured to implement the temperature control method according to claim 1.
